(19) United States
(12) Patent Application Publication
(10) Pub. No.: US 2004/0094115 A1
(43) Pub. Date: May 20, 2004

(54) Assembly for cooling a control module and a battery

(75) Inventors: Stefan Jatzke, Ebertsheim (DE); Paul White, Luton (GB)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignee: TRW Automotive Electronics & Components GmbH & Co. KG

(21) Appl. No.: 10/649,506

(22) Filed: Aug. 27, 2003

(30) Foreign Application Priority Data
Aug. 30, 2002 (DE) 202 13 397.4

(51) Int. Cl. B60K 13/02; B60R 16/04; H02J 7/00

(52) U.S. Cl. 123/198 E; 180/68.5; 180/68.3

(57) ABSTRACT

An assembly comprises a housing (10) for a battery (16) and a control module (18). The housing has an air inlet (20, 20′) and an air outlet (22). The air outlet (22) is adapted to be connected with the intake system of an engine of a motor vehicle.

### TECHNICAL FIELD

This invention relates to an assembly for cooling a control module and a battery for a motor vehicle.

### BACKGROUND OF THE INVENTION

The control module and the battery are usually disposed in the engine compartment of the vehicle. Lost heat arising is carried away by the ambient air, flow through the engine compartment increasing with increasing driving speed. During standstill of the vehicle, however, there is no flow through the engine compartment, so that the control module and the battery are cooled comparatively poorly.

It is the object of the invention to ensure the cooling of the control module and of the battery also during the standstill of the vehicle.

### BRIEF SUMMARY OF THE INVENTION

According to the invention, an assembly comprises a housing for a battery and a control module. The housing has an air inlet and an air outlet. The air outlet is adapted to be connected with the intake system of an engine of a motor vehicle. Since the combustion air of the engine of the vehicle is sucked in through the housing in which the control module and the battery are disposed, the air flow along the control module and the battery no longer is dependent on the general flow through the engine compartment, but an air flow is ensured also during the standstill of the vehicle due to the air intake by the engine.

### BRIEF DESCRIPTION OF THE DRAWINGS

FIG. 1 shows a sectional view of an assembly according to a first embodiment of the invention; and

FIG. 2 shows a sectional view of an assembly according to a second embodiment.

### DETAILED DESCRIPTION OF THE PREFERRED EMBODIMENTS

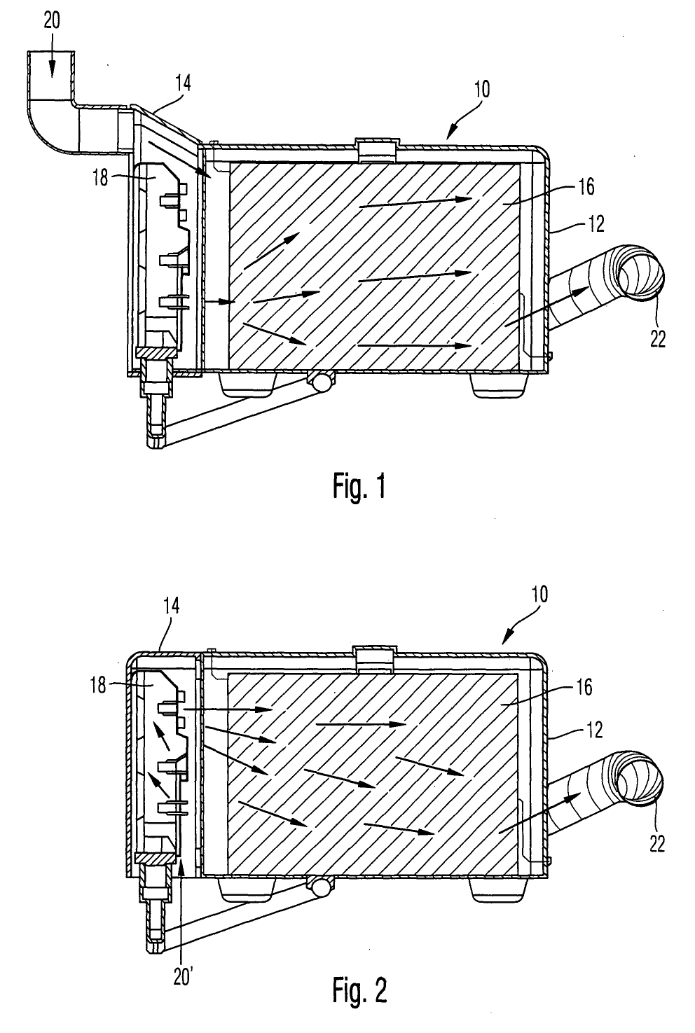

FIG. 1 shows a housing 10 which consists of a battery housing 12 and a control module housing 14. In the battery housing 12 a battery 16 is disposed, and in the control module housing 14 a control module 18 is disposed. The housing 10 has an air inlet 20, which here is connected below a windshield (not shown) of the vehicle. The housing 10 in addition has an air outlet 22, which is connected to an air filter (not shown) for an engine of a motor vehicle.

As soon as the engine is running and sucks in air, there is produced an air flow through the housing 10, which is indicated by the illustrated arrows. From the air inlet 20, the air flows through the control module housing 14, then from the same through the battery housing 12 and out of the housing 10 to the air outlet 22. This ensures a cooling both of the control module 18 and of the battery 16 independent of the driving speed of the vehicle.

According to an alternative aspect, the air inlet 20 can also be connected to an air-conditioning system. This ensures that at high outside temperatures, pre-cooled air is sucked in, which improves the cooling effect.

The battery housing 12 and the control module housing 14 preferably are arranged such that the interior of the control module housing 14 is accessible only from the side of the battery housing 12. Thus, stealing the control module 18 is made more difficult, as the battery 16 must first be removed, in order to have access to the control module 18.

FIG. 2 shows a second embodiment of the assembly. For the components known from the first embodiment, the same reference numerals are used, and in so far reference is made to the above explanations.

The difference with respect to the first embodiment consists in that in the second embodiment the air is sucked in directly from the engine compartment. Accordingly, the air inlet 20′ is formed here by a simple opening on the underside of the control module housing 14.

1. An assembly comprising a housing (10) for a battery (16) and a control module (18), said housing having an air inlet (20, 20′) and an air outlet (22), said air outlet (22) being adapted to be connected with an intake system of an engine of a motor vehicle.

2. The assembly as claimed in claim 1, characterized in that said housing (10) has a separate battery housing (12).

3. The assembly as claimed in claim 1, characterized in that said housing (10) has a separate control module housing (14).

4. The assembly as claimed in claim 1, characterized in that said air inlet (20) sucks in air from the vicinity of a windshield of said vehicle.

5. The assembly as claimed in claim 1, characterized in that said air inlet (20) sucks in air from an air-conditioning system.

6. The assembly as claimed in claim 1, characterized in that said air inlet (20′) sucks in air from an engine compartment.

7. The assembly as claimed in claim 1, characterized in that said battery (16) is disposed downstream of said control module (18).

8. The assembly as claimed in claim 1, characterized in that said control module (18) is accessible only after removal of said battery (16).
